(19) United States
(12) Patent Application Publication
(10) Pub. No.: US 2024/0284920 A1
(43) Pub. Date: Aug. 29, 2024

(54) APPARATUS FOR PRODUCING NOODLE SKIN PIECE

(71) Applicant: YUTAKA MFG. CO., LTD., Kounan-shi (JP)

(72) Inventors: Masayasu KURACHI, Kounan-shi (JP); Hideto OMI, Kounan-shi (JP)

(73) Assignee: YUTAKA MFG. CO., LTD., Kounan-shi (JP)

(21) Appl. No.: 18/436,360

(22) Filed: Feb. 8, 2024

(30) Foreign Application Priority Data
Feb. 28, 2023 (JP) 2023-029361

(51) Int. Cl. A21C 9/08

(52) U.S. Cl. CPC A21C 9/086; A21C 9/085

(57) ABSTRACT

An apparatus for producing noodle skin pieces comprises a mold roller, a rotary cutter, and a first cutter. The mold roller has a cylindrical body and/or a column body rotatable around a center line as a rotational axis. The first cutter is configured to cut noodle skin pieces from a noodle band. Female molds are formed on an outer peripheral surface of the mold roller. The mold roller is configured to form the noodle skin pieces on the surface of the noodle band by pressing the noodle band with the outer peripheral surface while rotating. The female mold has a center part that is the deepest in the female mold and has a peripheral part. The depth in the female mold becomes gradually shallow from the center part to an outer peripheral edge part of the female mold. The depth at the outer peripheral edge part is zero.

### CROSS-REFERENCE TO RELATED APPLICATIONS

This application claims priority to Japanese patent application serial number 2023-29361, filed on Feb. 28, 2023, the content of which is incorporated herein by reference in its entirety for all purposes.

### BACKGROUND

The present disclosure relates to an apparatus for producing noodle skin pieces which can be skins, such as dumpling wrappers and baozi.

A known dumpling wrapper has a peripheral part thinner than a center part. In this case, the dumpling wrapper (hereinafter referred to as a “noodle skin piece”) has cross-sectional shape where the peripheral part has different thickness than that of the center part, and each of the parts has uniform thickness. Although the peripheral parts are superimposed when ingredients are wrapped in the dumpling wrapper, the shape of the dumpling wrapper prevents the superimposed peripheral part from being thicker than the other parts. As shown in FIG. 15, a conventional apparatus has a cylindrical mold roller L and a recess-shaped female mold F. The mold roller L has an outer peripheral surface to produce noodle skin pieces M. The female mold F is provided on the outer peripheral surface of the roller L and is formed to correspond to the shape of the noodle skin pieces M to be formed. In this apparatus, noodle skin pieces formed in the female mold F are cut off from a noodle band MB through punching operation by punching cutter H. The noodle band MB where noodle skin pieces Mare cutoff becomes a scrap S.

In a specialized store, some noodle skin pieces that are handmade dumplings and/or baozi have mountain-shaped cross section. A center part of a noodle skin piece is formed thick. The thickness of the noodle skin piece become gradually reduced toward a peripheral part. Thus, thickness of superimposed peripheral parts does not become thicker compared to the other part when ingredients are wrapped in the noodle skin piece. This results in good texture of the skin. Additionally, the center part of the noodle skin piece has also good springy texture since the center part is formed thick.

In the case of the above-mentioned apparatus, when the punching operation is not performed in an appropriate timing, a part of a noodle band MB, which should be a scrap S, can be adhered to an outer peripheral edge parts of noodle skin pieces M without being cut off. Therefore, quality of products can be deteriorated since thicknesses of the outer peripheral edge parts of noodle skin pieces M partially become not uniform.

Thus, an improved apparatus for producing noodle skin pieces is expected.

### SUMMARY

Ina first embodiment of the present disclosure, an apparatus for producing noodle skin pieces comprises a mold roller and a first cutter. The mold roller has a cylindrical body and/or a column body rotatable around a center line as a rotational axis. The cutter is configured to cut noodle skin pieces from a noodle band. Female molds, which are used to form noodle skin pieces, are formed on an outer peripheral surface of the mold roller. The mold roller is configured to form the noodle skin pieces on the surface of the noodle band by pressing the noodle band with the outer peripheral surface while rotating. The female mold has a center part that is the deepest in the female mold and has a peripheral part. The depth in the female mold becomes gradually shallow from the center part to an outer peripheral edge part of the female mold. The depth at the outer peripheral edge part is zero. The mold roller has a blank part on the outer peripheral surface where the female molds do not exist. The blank part has an outer diameter that is the same as that of the outer peripheral edge part of the female mold.

According to the first embodiment, when noodle skin pieces are formed on the noodle band by the mold roller, a part of noodle band where the noodle skin pieces are not formed has the same thickness as that of outer peripheral edge parts of the noodle skin pieces. Thus, even if punching operation by the cutter is not performed in an appropriate timing, the thicknesses of the outer peripheral edge parts are formed uniform. Thus, the quality of products can be ensured.

Further, the thickness of the outer peripheral edge parts of the noodle skin pieces are formed thinner than that of the noodle band prior to the noodle skin pieces are formed. This allows an amount of noodle band that is processed as a scrap after cutting off the noodle skin pieces to be reduced.

### BRIEF DESCRIPTION OF THE DRAWINGS

FIG. 1 is a side view of an apparatus for producing noodle skin pieces according to a first embodiment of the present disclosure.

FIG. 2 is an enlarged schema of a side of a mold roller in the first embodiment.

FIG. 3 is an enlarged front view of the mold roller.

FIG. 4 is a developed view of a mold shape of the mold roller.

FIG. 5 is a cross sectional arrow view along line V-V of FIG. 4.

FIG. 6 is a cross sectional view of a noodle skin piece produced by an apparatus according to the first embodiment.

FIG. 7 is a cross sectional view of a mold roller in a second embodiment of the present disclosure corresponding to FIG. 5.

FIG. 8 is a front view of a noodle skin piece produced according to the second embodiment.

FIG. 9 is a cross sectional arrow view along line IX-IX of FIG. 8.

FIG. 10 is a side view of an apparatus for producing noodle skin pieces according to a third embodiment of the present disclosure.

FIG. 11 is a cross sectional view of a noodle skin piece produced according to the third embodiment.

FIG. 12 is a side view of an apparatus for producing noodle skin pieces according to a fourth embodiment of the present disclosure.

FIG. 13 is a side view of an apparatus for producing noodle skin pieces according to a fifth embodiment of the present disclosure.

FIG. 14 is a developed view of a mold shape in a mold roller in the fifth embodiment.

FIG. 15 is a side view of a conventional apparatus for producing noodle skin pieces.

### DETAILED DESCRIPTION

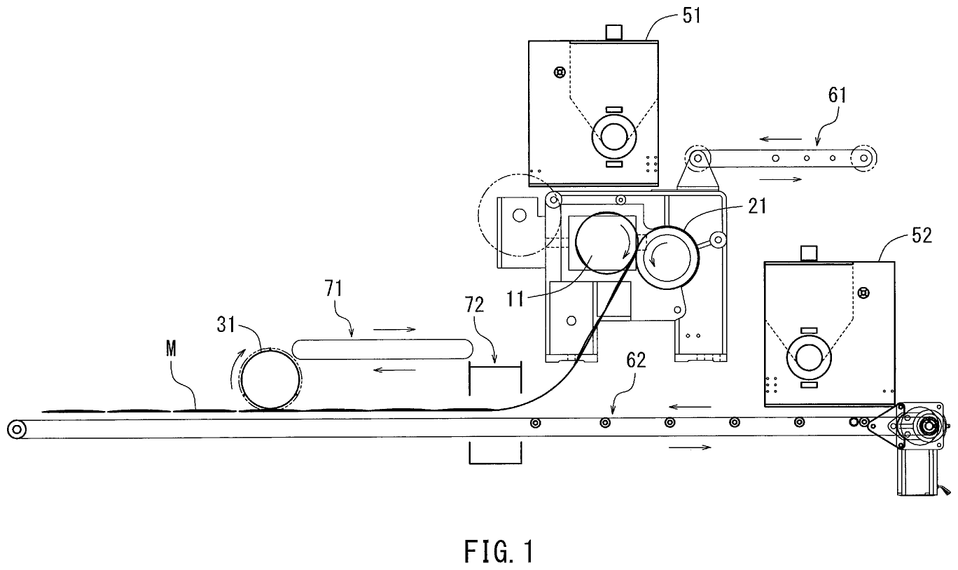

FIG. 1 shows an apparatus for producing noodle skin pieces according to the first embodiment. A noodle band (not shown) is conveyed from previous step by a conveyor 61. The noodle band passes through between a mold roller 11 and a press roller 21 to form noodle skin pieces M. Then, the noodle band is cut by a rotary cutter 31 to continuously produce noodle skin pieces. The noodle band is formed in belt-like shape in the previous step by rolling a lump that is made from weak flour, hard flour, and other ingredients mixed with water.

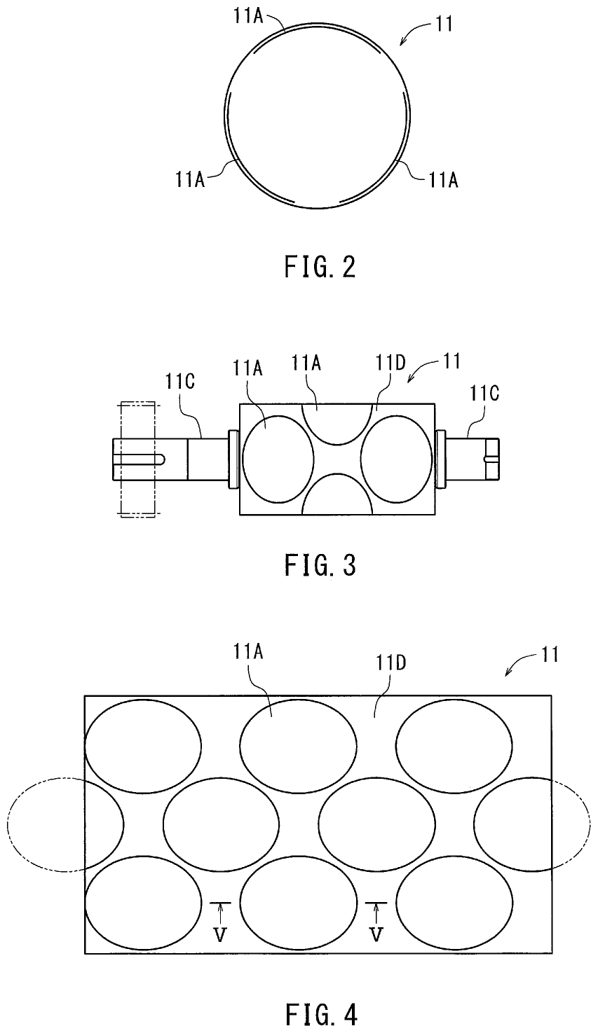

As shown in FIGS. 2-4, the mold roller 11 has an outer peripheral surface. For example, the mold roller 11 may be a cylindrical body or a column body. A plurality of female mold 11A, which is used to form noodle skin pieces M, is formed on the outer peripheral surface of the cylindrical body. For example, in the first embodiment, nine female molds may be formed. Specifically, the female molds 11A are formed in three rows in a shaft direction of the cylindrical body and in three rows in a circumferential direction. Thus, there are nine female molds 11A in a total in this embodiment. There are blank parts 11D in the outer peripheral surface of the mold roller 11 where the female molds 11A are not formed. The blank parts 11D are arranged to have spaces between the female molds 11A. Thus, as described later, it is easy to collect a remaining scrap of the noodle band after cutting off noodle skin pieces M by a rotary cutter since the remaining scrap of the noodle band is continuous without breaking apart. The rotary cutter corresponds to the first cutter.

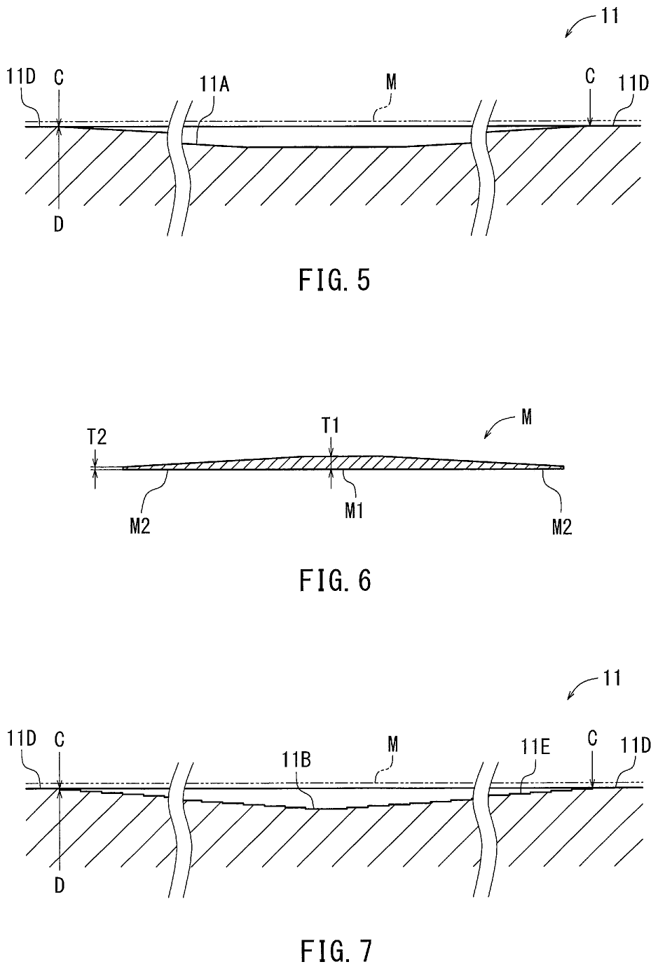

As shown in FIGS. 3-5, the female molds 11A are formed so that the depth of the female molds become gradually deeper from peripheral part to the center part. As shown in FIG. 5, an outer diameter of the blank part 11D is aligned with an outer diameter D that is substantially the same as that of the outer peripheral edge part of the female molds 11A. Although boundary lines between the outer peripheral edge parts and the blank parts 11D in the female molds 11A are clearly shown in FIGS. 3 and 4, the boundary lines are actually almost invisible. In FIG. 5, an imaginary line shows surfaces of the noodle skin piece M and the noodle band. The symbol C shows a boundary line between the outer peripheral edge part and the blank part 11D in the female mold 11A. It is noted that FIG. 5 shows a surface of the mold roller 11, which is originally circular arc shaped, developed into a planar shape.

The noodle band has high water content (around 50%) so as to be fit into the female molds 11A when forming noodle skin pieces M. Thus, rate of shrinkage after forming noodle skin pieces M is relatively high. Further, the rate of shrinkage is particularly high in the longitudinal direction of the noodle band due to the effect of rolling direction. Thus, the outer shape of the female mold 11A has an ellipse shape as shown in FIG. 4 that extend in the longitudinal direction of the noodle band.

As shown in FIG. 3, the mold roller 11 is configured to rotate around a shaft 11C provided on a center line of the cylindrical body. The detailed description of rotary drive mechanism of the mold roller 11 is omitted. As shown in FIG. 1, the press roller 21 is pressed against the outer peripheral surface of the mold roller 11. Thus, the noodle band delivered from the conveyor 61 is sandwiched between the outer peripheral surfaces of the mold roller 11 and the press roller 21 to be rolled. That is, the outer peripheral surface of the mold roller 11 is pressed against the surface of the noodle band while rotating. In this way, a part of the noodle band surface adjacent the mold roller 11 is pressed into the female molds 11A to form noodle skin pieces M. The thickness of the noodle band gets thinner as much as the part of the noodle band surface is pressed into the female molds 11A. As shown in FIG. 1, the noodle band M where noodle skin pieces M are formed on the surface is conveyed by a conveyor 62. Then, the noodle skin pieces M are cut off by the rotary cutter 31 located on downstream side of the conveyor 62. The rotary cutter 31 has a cylindrical body and is configured to rotate around a rotational shaft on a center line. The rotary cutter 31 has a cutting blade for cutting off noodle skin pieces M on the outer peripheral surface. The cutting blade is formed to correspond to the outer shape of the noodle skin pieces M. The rotary cutter 31 is configured to rotate in a synchronized manner with the mold roller 11. Thus, noodle skin pieces M can be cut off by the rotary cutter 31 without position shift.

In this way, the noodle skin pieces Mare cutoff. The noodle skin pieces Mare then packaged as products on the downstream side of the conveyor 62 and forwarded. FIG. 6 shows a cross sectional shape of the noodle skin piece M as a product. The noodle skin piece M is formed handmade-like and has a thick center part M1 where the thickness becomes gradually thinner toward a peripheral part M2. Thus, the noodle skin piece M has a mountain-shaped cross section. For example, the diameter of the noodle skin piece M may be about 106 mm. The thickness T1 of the center part M1 may be about 2.5 mm. The thickness T2 of the outer side of the peripheral part M2 may be about 0.7 mm.

As shown in FIG. 1, a scrap conveyor 71 is provided adjacent to the outer peripheral surface of the rotary cutter 31. The scrap conveyor 71 is configured to receive a scrap of a noodle band from the rotary cutter 31 after noodle skin pieces M are cut off, and then, convey the scrap to a chute 72. The chute 72 is located on the downstream side of the scrap conveyor 71 and is configured to collect and move the scrap to a scrap storage space. The scrap may be recycled as a noodle band. In FIG. 1, arrows show rotational direction and/or movement direction of the rotating bodies such as the mold roller 11 and the conveyors such as the conveyor 61.

As shown in FIG. 1, powder spreading machines 51 and 52 are provided above the mold roller 11 and above the upstream side of the conveyor 62. The powder spreading machines 51 and 52 are configured to spread powder such as starch powder on the outer peripheral surface of the mold roller 11 and on an upper surface of a belt of the conveyor 62. The powder spread on the noodle band prevents the noodle band from being adhered to the outer peripheral surface of the mold roller 11 and the upper surface of a belt of the conveyor 62.

Noodle skin pieces M are formed on a surface of a noodle band pressed on the outer peripheral surface of the mold roller 11. When the noodle skin pieces M are formed on the surface of the noodle band, the noodle skin pieces M are kept continuous with the noodle band without being cut off. The noodle skin piece M has an ellipse shape corresponding to outer shape of the female molds 11A in the outer peripheral surface of the mold roller 11.

The noodle band is conveyed on the conveyor 62. Then, the noodle skin pieces M are cut off from the noodle band by the rotary cuter 31. The noodle skin pieces M shrink as time pass and change the shape from the ellipse shape to substantially circle shape after being delivered as products. The noodle skin piece M as a product becomes a handmade-like noodle skin piece that has a thick center part M1 where the thickness becomes gradually thinner toward the peripheral part M2.

When the noodle skin pieces Mare formed on the noodle band, the blank parts 11D connecting the noodle skin pieces M have substantially the same thickness as that of outer peripheral edge parts of peripheral parts M2. Thickness T2 of the outer peripheral edge part of the peripheral part M2 in the noodle skin piece M becomes thinner than that of the noodle band before the noodle skin pieces are formed. Thus, an amount of the noodle band processed as scrap can be reduced. The thickness of the blank part 11D is substantially the same as that of the outer peripheral edge part of the peripheral part M2. Thus, even if cutting positions of the noodle skin pieces M, which are cut off by the rotary cutter 31, are shifted, the thickness of the outer peripheral edge parts of the noodle skin pieces M are not partially uneven. Thus, the marketability of the noodle skin pieces M can be secured since the positional shifts of the noodle skin pieces M are unremarkable.

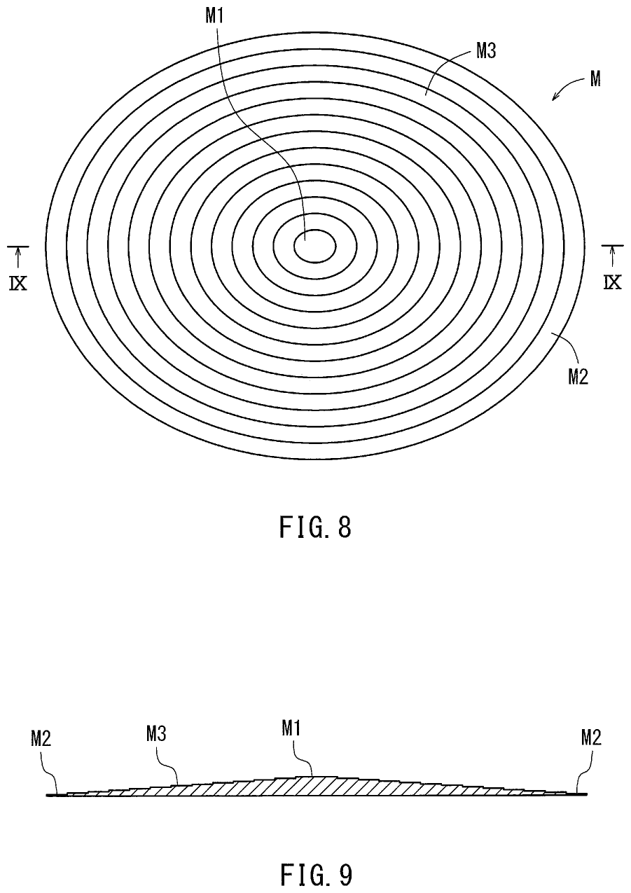

FIG. 7 shows a second embodiment of the present disclosure. The second embodiment is different from the first embodiment in that the shapes of the female molds are changed. In the first embodiment, the female mold 11A is configured to form the noodle skin piece M having the thick center part M1 and the thin peripheral part M2. Further, the noodle skin piece M is mountain-shaped to have smooth sloping plane as shown in FIG. 6. In the second embodiment, the thickness between the center part M1 and the peripheral part M2 is formed to change in a stepwise shape as shown in FIGS. 8 and 9. The other configurations of the second embodiment are substantially the same as that of the first embodiment. The description of the same configurations is omitted.

In the second embodiment, the thickness of the noodle skin piece M is changed in a stepwise manner between the center part M1 and the peripheral part M2 as shown in FIGS. 8 and 9. That is, the noodle skin piece M is formed to have a plurality of steps having parallel and flat surfaces M3. Thus, the female mold 11B is formed to be stepwise so that the depth gets deeper from the peripheral part to the center part as shown in FIG. 7. A molding surface of the female mold 11B for molding the surfaces M3 is formed to have arc surfaces 11E provided along the outer peripheral surface of the mold roller 11. In the second embodiment, the outer diameters D of the female molds 11B is the same as that of the female molds 11A on the blank part 11D side from a boundary line C between the outer peripheral edge part and the blank parts 11D, as the first embodiment. It is noted that FIG. 7 shows the surface of the mold roller 11 developed on a plane, which is originally arc shaped.

In the second embodiment, the female mold 11B is formed to be stepwise so that the depth gets deeper from the peripheral part to the center part. In this way, a substantial inclined plane of the female mold 11B is made in the stepwise shape. Thus, it is easy to generate CAD data to form the female mold 11B. This allows the female mold 11B to be easily manufactured. The stepwise marks on noodle skin pieces M can be inconspicuous by decreasing the height and the width of each step in the stepwise shape. Further, corners of the steps may be smoothed by hand finishing. In this way, the inclined plane of the female mold 11B can be smooth.

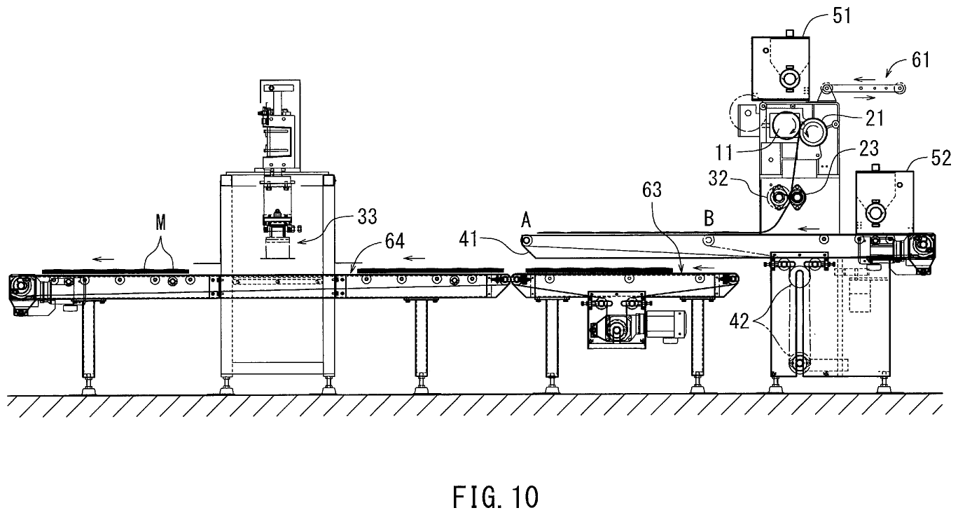

FIG. 10 shows a third embodiment of the present disclosure. The third embodiment is different from the first embodiments in the way of cutting of noodle skin pieces M from noodle bands. In the third embodiment, noodle skin pieces M may be cut off from stacked noodle bands at one time. Specifically, in the first embodiment, noodle skin pieces M are cut off one by one. However, in the third embodiment, a plurality of noodle skin pieces M is cut off at one time. The other configurations of the third embodiment are substantially the same as that of the first embodiment. The description of the same configurations is omitted.

As shown in FIG. 10, in the third embodiment, a rotary cutter 32 is located below the mold roller 11. The rotary cutter 32 is combined with a press roller 23. The rotary cutter 32 is configured to cut a noodle band in the width direction of the noodle band to have a predetermined length when the noodle band passes through between the rotary cutter 32 and the press roller 23. The noodle band is provided from between the mold roller 11 and the press roller 21. The noodle band to be cut includes noodle skin pieces M formed on its surface. For example, a noodle band may be cut to have 1 meter length in which five noodle skin pieces M may be included. The noodle band after being cut with the rotary cutter 32 is placed on a telescopic conveyor (also called as a shuttle conveyor) 41. The telescopic conveyor 41 is known and is configured to expand and contract its edge part between positions A and B shown in FIG. 10 by moving a conveyor roller 42 up and down. A conveyor 63 is provided below the telescopic conveyor 41. The telescopic conveyor 41 is configured to convey a noodle band placed on the telescopic conveyor 41 toward the edge part of the telescopic conveyor 41 while the edge part moves from the position A to the position B at the same speed. Thus, the telescopic conveyor 41 can move the noodle band having a predetermined length onto the conveyor 63 without moving the noodle band in the moving direction of the telescopic conveyor 41 each time the edge part of the telescopic conveyor 41 moves from the position A to the position B. Thus, the cut noodle bands are stacked on the conveyor 63 in a state that surfaces of the noodle skin pieces M face the same direction (upward direction in FIG. 10). The rotary cutter 32 corresponds to a second cutter.

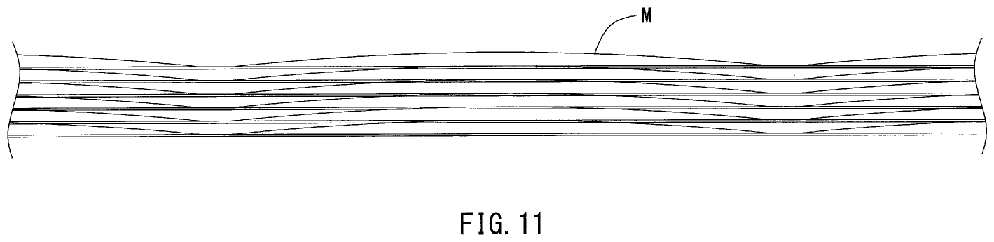

The conveyor 63 is configured to convey the stacked noodle bands to the next conveyor 64 each time when the number of the stacked noodle band on the conveyor 63 reaches a predetermined number (e.g., 10 pieces) of the noodle bands. As a result, the stacked noodle bands are conveyed onto the conveyor 64 as one group when the number of the stacked noodle bands reaches the predetermined number. FIG. 11 shows the stacked noodle bands. As shown in FIG. 11, noodle skin pieces M of each noodle band are stacked in the vertical direction so that phases of the noodle skin pieces M are aligned in the conveying direction. That is, the noodle skin pieces M of each noodle band are stacked while being aligned in the front-back direction and the horizontal direction.

A punch cutter 33 is provided at the middle of the conveying route of the conveyor 64. The punch cutter 33 is configured to punch the stacked noodle bands in the stack direction to cut off set number of noodle skin pieces M at one time when the conveyor 64 stops. At this time, for example, the punch cutter 33 may punch three pieces of noodle skin pieces M at one time, which is arranged in the width direction of the noodle band. In this case, the stacked noodle skin pieces M, which were punched by the punch cutter 33, are conveyed toward downstream by the conveyor 64 in three lines. In the downstream of the conveyor 64, the noodle skin pieces M are packed as products and then shipped.

In the third embodiment, a plurality of noodle skin pieces M is formed on a noodle band. However, at least one noodle skin piece M may be formed on a noodle band. Further, in the third embodiment, the conveyor 63 conveys the stacked noodle bands to the conveyor 64. However, the conveyor 63 may convey a noodle band one by one to the conveyor 64. Then, each noodle band may be punched by the punch cutter 33.

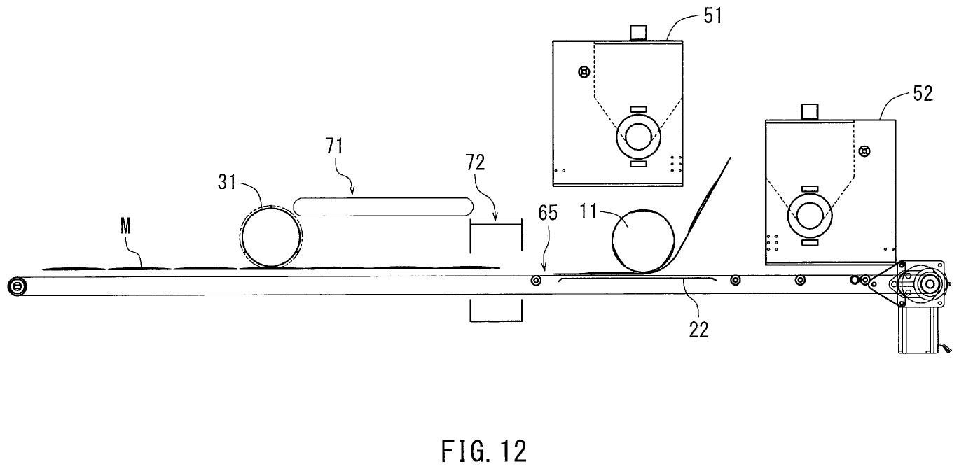

FIG. 12 shows a fourth embodiment of the present disclosure. The fourth embodiment is different from the first embodiments in that the outer peripheral surface of the mold roller 11 has improved structure for pressing a noodle band. The other configurations of the fourth embodiment are substantially the same as that of the first embodiment. The description of the same configurations is omitted.

As shown in FIG. 12, in the fourth embodiment, the mold roller 11 is located above the conveyor 65. A support table 22 is located under an upper belt of the conveyor 65 to face the mold roller 11. A rotational shaft of the mold roller 11 is arranged to extend across the belt of the conveyor 65. The outer peripheral surface of the mold roller 11 is located to hold a noodle band with an upper surface of the upper belt of the conveyor 65. The support table 22 has a flat plane on its upper surface which is along a lower surface of the upper belt of the conveyor 65. The size of an upper surface of the support table 22 in the width direction of the belt of the conveyor is slightly larger than that of the outer peripheral surface of the mold roller 11 in the rotational shaft direction. In the longitudinal direction of the belt of the conveyor 65, the upper surface of the support table 22 is set as enough larger than the diameter of the outer peripheral surface of the mold roller 11. Further, the support table 22 is designed so that interfacial friction between the upper surface of the support table 22 and the lower surface of the upper belt of the conveyor 65 is suppressed as far as possible.

When a noodle band is passed between the outer peripheral surface of the mold roller 11 and the upper surface of the upper belt of the conveyor 65, the noodle band is pressed on the outer peripheral surface of the mold roller 11 by the upper surface of the upper belt of the conveyor 65. In this way, noodle skin pieces Mare formed on the surface of the noodle band. In this step, reaction force against force applied from the upper surface of the upper belt of the conveyor 65 to press the noodle band against the outer peripheral surface of the mold roller 11 is supported by the support table 22.

The noodle band where the noodle skin pieces M are formed is conveyed by the conveyor 65 and then, the noodle skin pieces M are cut off separately. The noodle skin pieces M are further conveyed to the downstream and delivered as products.

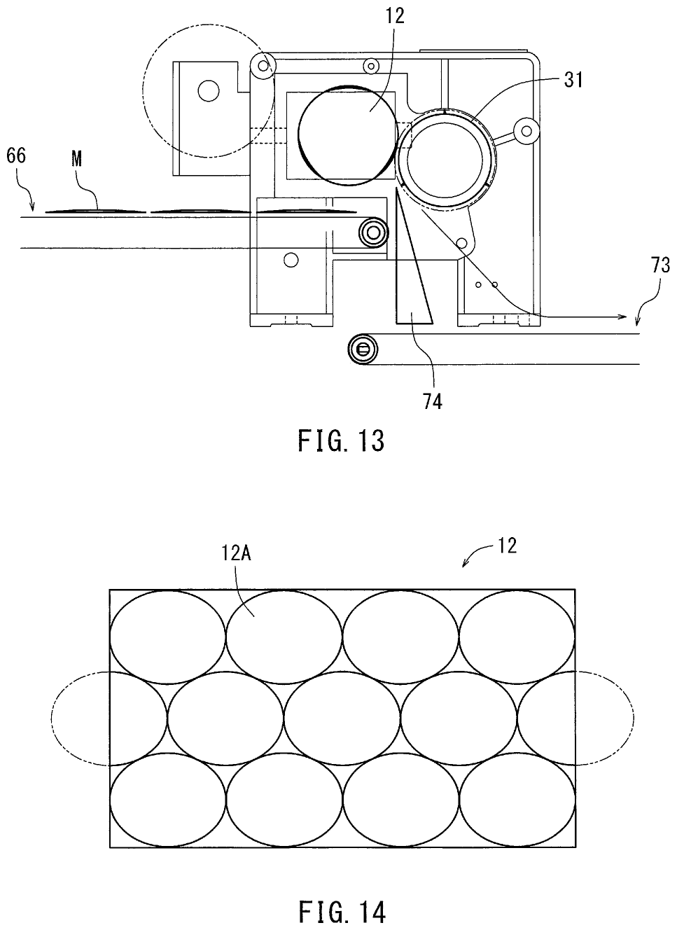

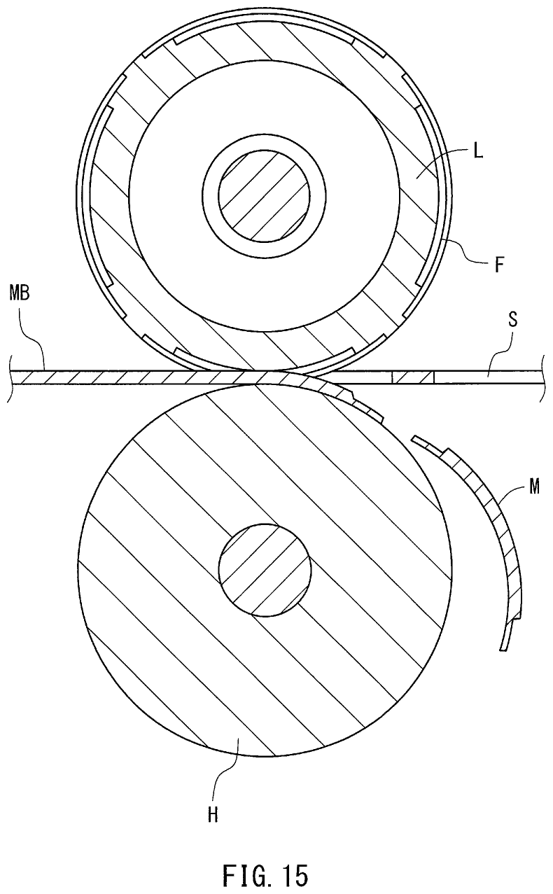

FIG. 13 shows a fifth embodiment of the present disclosure. The fifth embodiment is different from the first embodiments in that the press roller 21 and the rotary cutter 31 are united. Since the press roller 21 has the same function as a cutter, noodle skin pieces M formed by the mold roller 12 are cut off separately when the noodle skin pieces M are separated from the mold roller 12. A tip part of a chute 74 is provided near a boundary between the outer peripheral surface of the mold roller 12 and the outer peripheral surface of the rotary cutter 31. Further, the outer peripheral surface of the mold roller 12 is provided with female molds 12A as shown in FIG. 14. The female molds 12A are formed in four rows in the rotary shaft direction (three pieces in each row) and in three rows in the circumferential direction (four pieces in each row). Thus, there are twelve female molds 12A in a total. The female molds 12A are arranged to contact each other. The other configurations of the fifth embodiment are substantially the same as that of the first embodiment. The description of the same configurations is omitted.

When the noodle band is put through between the outer peripheral surface of the mold roller 12 and the outer peripheral surface of the rotary cutter 31, noodle skin pieces M are formed on the surface of the noodle band by the female molds 12A of the mold roller 12. At this time, the noodle skin pieces M are cut off by the rotary cutter 31 from the noodle band. The noodle skin pieces M are separated from the female molds 12A due to centrifugal force and gravity, and then the noodle skin pieces M are distributed to the conveyor 66 by the tip part of the chute 74. The remaining noodle band where the noodle skin pieces M are separated is distributed to a scrap conveyor 73 by the tip part of the chute 74. The noodle skin pieces M are delivered as products. The scrap noodle band is recycled on the downstream side of the scrap conveyor 73. In this case, the scrap noodle band may be cut in pieces.

Although the specific embodiments are described above, the present disclosure is not limited to their appearance and/or configurations. Various changes, addition, and deletion are possible to the present disclosure. For example, in the above embodiments, the mold roller and the rotary cutter are formed in cylindrical shapes. However, these may be formed in column shape. Further, in the above embodiments, the outer shape of the female mold has an ellipse shape. However, when the noodle skin pieces separated from the noodle band has the substantially the same shrinkage rates in the longitudinal and the width directions as that of the noodle band, the female mold may have substantially perfect circle shape. Furthermore, in the above embodiments, a plurality of female molds are formed on the outer peripheral surface of the mold roller. However, only one female mold may be formed on the outer peripheral surface of the mold roller.

What is claimed is:

1. An apparatus for producing noodle skin pieces, the apparatus comprising:
a mold roller being a cylindrical body or a column body being rotatable around a center line of the cylindrical body or the column body as a rotational axis,
a first cutter for cutting the noodle skin pieces from a noodle band, the noodle skin pieces are formed on a surface of the noodle band; and
a plurality of female molds formed on an outer peripheral surface of the mold roller and configured to form the noodle skin pieces,
wherein the mold roller is configured to form the noodle skin pieces on the surface of the noodle band by pressing the noodle band with the outer peripheral surface while rotating,
wherein each of the plurality of female molds has a center part being a depth in the female mold and has a peripheral part, the depth in the female mold becoming gradually shallow from the center part to an outer peripheral edge part of the female mold, a depth at the outer peripheral edge part being zero, and
wherein the mold roller has a blank part on the outer peripheral surface where the female molds do not exist, the blank part having an outer diameter that is the same as that of the outer peripheral edge part of the female mold.

2. The apparatus according to claim 1, wherein the female mold is formed to have the depth being changeable from the outer peripheral edge part to the center part step by step, wherein a slope of a mountain-shaped cross section of the noodle skin piece is formed having a plurality of steps, and wherein each of the plurality of steps is different in height and arranged in parallel to each other.

3. The apparatus according to claim 1, wherein the first cutter is a rotary cutter having a cutting edge formed on an outer peripheral surface of the mold roller, wherein a shape of the cutting edge corresponds to an outer shape of the female mold, and wherein the first cutter is configured to cut off noodle skin pieces on the outer peripheral surface one by one from the noodle band.

4. The apparatus according to claim 1 further comprises:
a second cutter configured to cut the noodle band in a predetermined length to include at least one noodle skin piece in the longitudinal direction of the noodle band, and a plurality of conveyors, wherein
a first conveyor of the plurality of conveyors is configured to place the noodle band being cut by the second cutter on a second conveyor of the plurality of conveyors, wherein the first cutter is configured to punch the noodle skin pieces on the noodle band in the thickness direction of the noodle band conveyed by the second conveyor to cut off the noodle skin pieces from the noodle band.

5. The apparatus according to claim 1 further comprises a press roller located adjacent to the mold roller, wherein a rotation of the press roller in combination with a rotation of the rotary cutter are synchronized with a rotation of the mold roller.

6. The apparatus according to claim 1 further comprises a scrap conveyor located adjacent to an outer peripheral surface of the rotary cutter, the scrap conveyor is configured to receive a scrap of the noodle band from the rotary cutter.

7. The apparatus according to claim 1 further comprises a chute located on a downstream side of the scrap conveyor, the chute is configured to collect and move the scrap to a scrap storage for recycling into a noodle band.

8. An apparatus for producing noodle skin pieces, the apparatus comprising:
a mold roller being a cylindrical body or a column body being rotatable around a center line of the cylindrical body or the column body as a rotational axis, and
a rotary cutter configured to combine with a press roller for cutting a noodle band in a width direction of the noodle band in a predetermined length; and
a first cutter for cutting the noodle skin pieces from a noodle band, the noodle skin pieces are formed on a surface of the noodle band; and
a plurality of female molds formed on an outer peripheral surface of the mold roller and configured to form the noodle skin pieces,
wherein the mold roller is configured to form the noodle skin pieces on the surface of the noodle band by pressing the noodle band with the outer peripheral surface while rotating,
wherein each of the plurality of female molds has a center part being a depth in the female mold and has a peripheral part, the depth in the female mold becoming gradually shallow from the center part to an outer peripheral edge part of the female mold, a depth at the outer peripheral edge part being zero, and
wherein the mold roller has a blank part on the outer peripheral surface where the female molds do not exist, the blank part having an outer diameter that is the same as that of the outer peripheral edge part of the female mold.

9. The apparatus according to claim 8 further comprises a telescopic conveyor and a conveyor positioned below the telescopic conveyor and configured for stacking the noodle bands to include a predetermined number of the noodle band, preferably 10 noodle bands.

10. The apparatus according to claim 8 further comprises a shaft positioned on a center line of the cylindrical body.

11. The apparatus according to claim 10 wherein the mold roller is configured to rotate around the shaft.

12. The apparatus according to claim 9 further comprises a plurality of powder spreading machines located above the mold roller and an upstream side of the conveyor, wherein each of the plurality of powder spreading machines is configured to spread powder on the outer peripheral surface of the mold roller and on an upper surface of the conveyor.

13. The apparatus according to claim 9 further comprises a punch cutter configured to punch the stacked noodle bands in a stack direction for cutting the noodle skin pieces at once.
